(19) United States
(12) Patent Application Publication
(10) Pub. No.: US 2006/0196772 A1
(43) Pub. Date: Sep. 7, 2006

(54) Microfluidic device including membrane having nano- to micro-sized pores and method of separating polarizable material using the same

(76) Inventors: Sook-young Kim, Gyeonggi-do (KR); Yoon-kyoung Cho, Gyeonggi-do (KR); Soo-hwan Jeong, Gyeonggi-do (KR); Jin-tae Kim, Gyeonggi-do (KR); Chin-sung Park, Gyeonggi-do (KR)

Correspondence Address: CANTOR COLBURN, LLP, 55 GRIFFIN ROAD SOUTH, BLOOMFIELD, CT, 06002, US

(21) Appl. No.: 11/350,479

(22) Filed: Feb. 9, 2006

(30) Foreign Application Priority Data
Feb. 12, 2005 (KR) 10-2005-0011734

(51) Int. Cl. B03C 5/02

(52) U.S. Cl. 204/547; 204/643

(57) ABSTRACT

Provided are a microfluidic device for separating polarizable analytes via dielectrophoresis, the device including: a microchannel including a membrane having nano- to micro-sized pores; at lest two electrodes generating a spaciously non-uniform electric field in the nano- to micro-sized pores when an AC voltage is applied; and a power source applying the AC voltage to the electrodes, and a method of separating polarizable target materials using the device.

### CROSS-REFERENCE TO RELATED PATENT APPLICATIONS

This application claims the benefit of Korean Patent Application No. 10-2005-0011734, filed on Feb. 12, 2005, in the Korean Intellectual Property Office, the disclosure of which is incorporated herein in its entirety by reference.

### BACKGROUND OF THE INVENTION

1. Field of the Invention

The present invention relates to a microfluidic device including a membrane having nano- to micro-sized pores and a method of separating polarizable material using the same.

2. Description of the Related Art

Particles that can be dielectrically polarized in a non-uniform electric field experience a dielectrophoretic (DEP) force when the particles have different effective polarizability from a surrounding medium, even if dielectrically polarizable particles do not have electric charges. The motion of particles is determined by dielectric properties (for example, conductivity and permittivity), not by electric charges of the particles, which is well known in electrophoresis.

The DEP force applied to a particle may be given by:

$${F}_{DEP} = 2 π {a}^{3} {ɛ}_{m} Re ( \frac{{ɛ}_{p} - {ɛ}_{m}}{{ɛ}_{p} + 2 {ɛ}_{m}} ) ∇ {E}^{2} \qquad ( 1 )$$

where F_{DEP} is a DEP force applied to a particle, a is a diameter of the particle, εₘ is permittivity of a medium, εₚ is permittivity of the particle, Re is a real part, E is an electric field, and ∇ is a del vector operation. As shown in Equation 1, the DEP force is proportional to the volume of the particle, to the difference between the permittivity of the medium and the permittivity of the particle, and to the gradient of the square of the strength of an electric field.
CM (Clausius-Mossotti) factor=RE[εₚ*−εₘ*]/(εₚ*+2εₘ*) (2)
where ε* is a complex permittivity and is given by ε*=ε−i(σ/ω) whereσ is conductivity and ω=2πf. When the CM factor is greater than 0, the DEP force is positive and the particle is attracted to a high electric field gradient region. When the CM factor is less than 0, the DEP force is negative and the particle is attracted to a low electric field gradient region.

As shown in Equations 1 and 2, the DEP force applied to the particle depends on the conductivity of the medium and a frequency of an AC voltage and a voltage.

Meanwhile, a device for separating polarizable analytes via DEP has been developed. For example, U.S. Patent Publication No. 2004/0011650 discloses a device, which includes a concentration module in electronic communication with an electrode, at least one detection module including capture probes, and a power source, to handle polarizable analytes via DEP and to detect a target analyte. The concentration module of the device includes at least one physical constriction to allow the generation of an asymmetrical electric field. Although the use of the constriction structure may result in an increase of the generation of the asymmetrical electric field, the constriction can interrupt the flow of the fluid, thereby stopping the flow of the fluid. Accordingly, the device can be used only for enrichment of a target material or detection of the enriched target material. In other words, the device may not be suitable for separating a material.

In response to this problem, the inventors of the present invention have developed a device that can increase the generation of an asymmetric electric field and separate polarizable materials via DEP while not interrupting the flow of the fluid, and have found that the asymmetric electric field can be induced by using a membrane having nano- or micro-sized pores that does not interrupt the flow of the fluid.

### SUMMARY OF THE INVENTION

The present invention provides a device that can easily separate large quantities of polarizable analytes while the flow of a fluid is not interrupted.

The present invention also provides a method of separating a target material using the device.

According to an aspect of the present invention, there is provided a microfluidic device for separating polarizable analytes via dielectricphoresis, the device comprising: a microchannel comprising a membrane having nano- to micro-sized pores; at least two electrodes generating a spaciously non-uniform electric field in the nano- to micro-sized pores when an AC voltage is applied; and a power source applying the AC voltage to the electrodes.

According to another aspect of the present invention, there is provided a method of separating a target material from a sample via dielectricphoresis using the microfluidic device of any one of claims 1 through 6 comprising: the microchannel including the membrane having nano- to micro-sized pores, at least two electrodes, and the power source, the method comprising: contacting the sample and the membrane having nano- to micro-sized pores; and generating a spaciously non-uniform electric field in the vicinity of the nano- to micro-sized pores of the membrane by applying an AC voltage to the electrodes by the power source so that the target material is separated from the sample via dielectrophoresis.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a microfluidic device according to an embodiment of the present invention;

FIG. 2 illustrates steps in a process for enriching or separating a material via (−) dielectrophoresis (DEP) using the microfluidic device of FIG. 1;

FIG. 3 is a schematic view of a microfluidic device according to another embodiment of the present invention;

FIG. 4 illustrates steps in a process for enriching or separating a material via (+) dielectrophoresis (DEP) using the microfluidic device of FIG. 3;

FIG. 5 is a graph illustrating a DEP property with respect to a frequency of latex beads having diameters of 50 nm and 200 nm;

FIG. 6 is a view illustrating a separation result of latex beads having diameters of 50 nm and 200 nm using the microfluidic device of FIG. 1, which includes a membrane with a thickness of 2 μm, pores of 2 μm in diameter, and electrodes respectively separated from the membrane by a distance of 50 μm;

FIG. 7 is a view illustrating an electric field distribution adjacent to a membrane when an electric field is applied to the microfluidic device of FIG. 3 which includes the membrane which has a thickness of 2 μm, pores of 2 μm in diameter, and electrodes respectively contacting the membrane; and

FIG. 8 is a view illustrating separation results of latex beads having diameters of 50 nm and 200 nm using the microfluidic device of FIG. 3, which includes the membrane with a thickness of 2 μm, pores of 2 μm in diameter, and electrodes respectively contacting the membrane.

### DETAILED DESCRIPTION OF THE INVENTION

According to an aspect of the present invention, there is provided a microfluidic device for separating polarizable analytes via dielectrophoresis (DEP), the device including: a) a microchannel including a membrane having nano- to micro-sized pores; b) at least two electrodes generating a spaciously non-uniform electric field in the nano- to micro-sized pores when an AC voltage is applied; and c) a power source supplying the AC voltage to the electrodes.

In general, a “microfluidic device” is a device that is suitable for handling a small amount of fluid, for example, a nano liter or micro liters of fluid. However, in some cases, the amount of the fluid can be greater or lower than the nano or microliters. The structure of the microfluidic device may be of nanometer or millimeter dimensions, and preferably, micrometer dimensions. The microfluidic device according to an embodiment of the present invention can be manufactured using conventional methods and materials. The microfluidic device according to an embodiment of the present invention can be manufactured using photolithography, softlithography, hotembossing, elastomer molding, injection molding, LIGA, SFIL, silicon fabrication, or similar methods. However, the method of manufacturing the microfluidic device is not limited thereto.

The microfluidic device according to an embodiment of the present invention includes a membrane having nano- to micro-sized pores in a microchannel. The microchannel and the membrane can be formed of various materials, and in particular, they can be formed of the same material or different materials. For example, the microchannel and the membrane may be formed of an insulating material, which can be a silicon wafer, glass, fused silicon, a plastic material, or the like, but is not limited thereto. The geometry of the membrane in the channel may vary, and preferably, the membrane may be disposed horizontally in the microchannel perpendicular to the flowing direction of the fluid or in a direction making a predetermined angle with the flowing direction of the fluid. As a result, the membrane resists the flow of the fluid, and the fluid flows through the nano- to micro-sized pores formed in the membrane.

In the present invention, “channel” or “microchannel” encompasses a space that can contain a fluid having a predetermined volume in the microfluidic device. In general, “channel” or “microchannel” is referred to as a region designed such that fluid can flow from one end to the other end. In some embodiments, the channel is designed such that fluid can contact an electrode, nano- to micro-sized pores, a detector, and the like. The channel may be formed to have a predetermined shape. For example, the channel may be linear, bent, or arc-like. In addition, the channel may have a cross section of a pentagonal, rectangular, or circular shape. The size of the cross section of the channel may vary according to its length. The channel can be be completely included in the device, or can be opened enabling the introduction or removal of a sample. The depth of the channel may be in the range of 0.1 μm to 5000 μm, and preferably, 2 μm to 1000 μm. The width of the channel may be in the range of 2 μm to 500 μm, and preferably, 3 μm to 100 μm.

In the microfluidic device according to an embodiment of the present invention, the membrane of the microchannel may have a thickness of 0.1 μm to 500 μm. The diameter of the nano- to micro-sized pore may vary according to the strength of the AC voltage applied between electrodes, frequency, and the like, and may be in the range of 1 nm to 50 μm. The microfluidic device according to an embodiment of the present invention includes nano-sized pores that can effectively separate nano- to micro-sized polarizable analytes. The absolute and comparative widths and depths of the pore may be easily determined by those of ordinary skill in the art depending on target materials to be analyzed and conditions thereof. The depth of the pore may be similar to the thickness of the membrane. That is, the depth of the pore may be in the range of 0.1 μm to 500 μm. The nano- to micro-sized pore may be formed in the membrane using various methods known in the art. For example, the nano- to micro-sized pore can be formed using photolithography or anodization.

In the microfluidic device according to the current embodiment of the present invention, the electrode generates “an asymmetric electric field” that is spaciously non-uniform in a nano- to micro-sized pore region formed in the membrane of the microchannel. An asymmetric electric field indicates an electric field that has at least one maximum or minimum value in a device. Even if the microfluidic device includes symmetric components, e.g. pattern of electrodes, the “asymmetric field” described in the present specification is intended to mean the analytes are exposed in an asymmetric electric-field. That is, the analytes are subjected to a non-uniform electric field in the present invention.

The asymmetry can be obtained using various methods. In an embodiment of the present invention, the asymmetry can be obtained by the nano- to micro-sized pores formed in the membrane of the channel, or by the geometry of the electrode. The electrode may be formed of a conductive material, for example, one selected from the group consisting of a metal, such as Al, Au, Pt, Cu, Ag, W, or the like; a metal oxide, such as ITO or SnO₂; a conductive plastic; and a metal-impregnated polymer. The electrode may be separated from the membrane by a varying distance. For example, the electrode may contact the membrane. The distance between the electrode and the membrane may vary according to a target material, the object for separation, or the like.

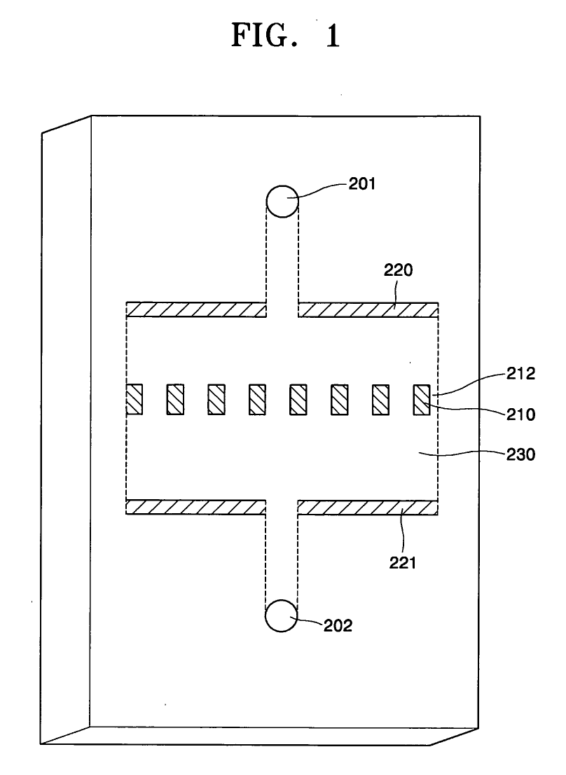

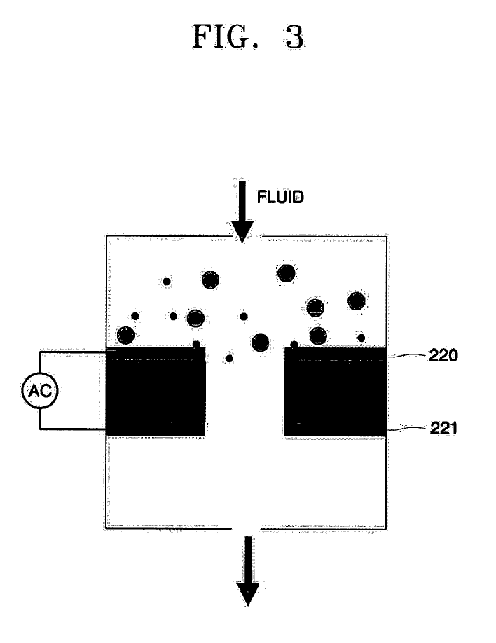

In the microfluidic device according to an embodiment of the present invention, the power source is connected to the electrode so that it can supply the AC voltage to the electrodes. When the AC voltage is supplied to the electrodes by the power source, an asymmetric electric field having at least one maximum or minimum value is generated in the device, and thus, polarizable materials that are included in a sample contained in the device experiences a DEP force. These polarizable materials may experience different DEP forces according to respective DEP forces, volumes and the like, and are thereby separated from each other. In this case, the separation of the materials may occur in various locations. For example, as illustrated in FIG. 1, when the electrodes can be separated from the membrane such that the weakest electric field occurs in the pore of the membrane, a material with a (+) DEP property may flow out through the pore, and a material with a (−) DEP property may be enriched in the membrane. In this case, the distance by which the electrodes and the membrane are separated may vary according to the depth or shape of the pores and may be 50 μm or greater, and preferably, 50 μm to 5 mm. Alternatively, as illustrated in FIG. 3, when the electrodes are adjacent to the membrane such that the strongest electric field occurs in the pore of the membrane, the material with the (+) DEP property may be enriched in the vicinity of the membrane and the material with the (−) DEP property may be enriched in a region which is separated from the pores of the membrane. In this case, the distance between the electrode and the membrane may vary according to the depth and shape of the pores, and may be in the range of 0 (when the electrode contacts the membrane) to 1 μm or less.

According to an embodiment of the present invention, various voltages and frequencies can be applied to the electrodes by the power source according to dielectric properties of a target material that is to be analyzed and properties of a medium. The frequency may be in the range of 1 Hz to 1 GHz, and preferably, 100 Hz to 20 MHz. In addition, a pick-to-pick (pp) voltage may be in the range of 1 V to 1 kV. The power source may be connected to a power source electronic device such as a power source amplifier, or a power conditioning device.

The microfluidic device according to an embodiment of the present invention may include a variety of factors (hereinafter refer to as “modules”) depending on its use. These modules include, but are not limited to: sample inlet ports; sample introduction or removal modules; cell handling modules; separation modules for electrophoresis, gel filtration, ion exchange chromatography, etc.; reaction modules for chemical or biological alteration of the sample, including amplification of the target analyte; fluid pumps; fluid valves; thermal modules for heating and cooling; storage modules for assay reagents; mixing chambers; and detection modules.

According to another aspect of the present invention, there is provided a method of separating a target analyte from the sample using the microfluidic device, which includes a microchannel including a membrane having nano- to micro-sized pores, at least two electrodes, and a power source. The method includes: contacting the sample with the membrane having nano- to micro-sized pores; and generating a spaciously non-uniform electric field in the vicinity of the nano- to micro-sized pores of the membrane by applying an AC voltage to the electrode by the power source so that polarizable materials of the sample are separated via DEP.

The method according to an embodiment of the present invention includes applying the sample to the membrane having nano- to micro-sized pores using the flow of the sample. Pumps may be used to produce a sample flow and can be contained within the device (on chip pump) or outside the device (off chip pump). In a preferred embodiment, on-chip pumps are used i.e., the pumps are contained within the device. These pumps are generally electrode-based pumps. That is, the application of electric fields can be used to move both charged particles and bulk solvent, depending on the composition of the sample and of the device. Suitable on chip pumps include, but are not limited to, electroosmotic (EO) pumps, electrohydrodynamic (EHD) pumps, and magneto-hydrodynamic (MHD) pumps. These electrode-based pumps have sometimes been referred to in the art as “electrokinetic (EK) pumps”.

The method according to an embodiment of the present invention also includes applying an AC voltage to the electrodes from the power source so that a spaciously non-uniform electric field is generated in the vicinity of the nano- to micro-sized pores of the membrane, thus separating polarizable materials from the sample via DEP. DEP is the process by which polarizable particles are drawn toward an electric field maximum or minimum. The DEP force depends on the volume and dielectric properties of the particles. Depending on the relative complex permittivities of the analyte and the sample medium, the target analyte will either be attracted (positive DEP) or repelled (negative DEP) to or from the electric field maximum. Some target analytes will experience neither positive DEP nor negative DEP in the same medium depending on the frequency of the applied electric field. Thus, in the method of separating a target analyte according to an embodiment of the present invention, the asymmetric electric field is generated by nano- to micro-sized pores of the membrane, and the strength and frequency of the electric field need to be sufficiently controlled to manipulate the chosen analyte.

In the method according to an embodiment of the present invention, “the target material is separated’ means that the target material is highly enriched at a specific point of the microfluidic device, or that the enriched target material is eluted to the outside. Thus, the method according to an embodiment of the present invention may further include detecting the target material that is enriched in a specific point in the device. The detection may be performed using conventional methods, such as identifying a target material using a probe material that binds the target material. In addition, the method according to an embodiment of the present invention may include eluting the target material that is enriched at a specific point in the device to the outside. In the eluting process, first, non-target materials are removed by washing with a washing solution, and then, the target material that is enriched at a specific point in the device according to an embodiment of the present invention is eluted. The elution may be performed with a material having the CM factor of almost 0, or performed by washing when the voltage is removed.

FIG. 1 is a schematic view of a microfluidic device according to an embodiment of the present invention. An inlet port 201 is connected to an outlet port 202 through a microchannel 230. The microchannel 230 includes a membrane 201 which has a plurality of nano- to micro- sized cylindrical pores and is disposed perpendicular to a fluid flow direction from the inlet port 201 to the outlet port 202. Electrodes 220 and 221 are respectively separated from the membrane 210 by a predetermined distance. A power source (not shown) is connected to the electrodes 220 and 221. In addition, other devices, such as a detector, can be selectively included in the device according to the current embodiment of the present invention. In FIG. 1, the device according to an embodiment of the present invention has cylindrical pores. However, those of ordinary skill in the art may acknowledge that the pores can have other shapes, such as slits. Accordingly, the scope of the present invention is not limited by the shape, structure, and size of the pores illustrated in FIG. 1. In addition, the absolute and relative widths of the pores and depths of the pore can be easily controlled by those of ordinary skill in the art according to the target material to be separated and conditions thereof. The depth of the pores may be similar to the thickness of the membrane, and may be in the range of 0.1 to 500 μm.

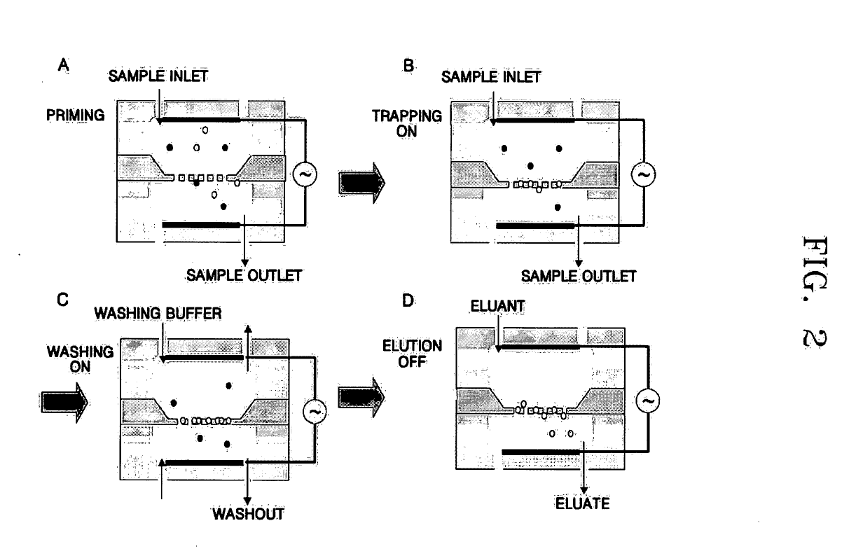

FIG. 2 illustrates steps in a process for enriching or separating a material via a (−) DEP using the microfluidic device of FIG. 1. The separation of a material using the microfluidic device of FIG. 1 may be performed by: a) injecting a sample fluid to the device (priming); b) generating a spaciously asymmetric electric field by a power source to trap cells, molecules, or particles in the pores, wherein the pores experience a weak electric field so that only material with a (−) DEP property is trapped in the pores and other materials pass through the pore; c) washing the inside of the microchannel with a washing buffer; and d) removing the spaciously asymmetric electric field by turning off the power source, and eluting the enriched target material from the device. Although FIG. 2 illustrates an operation of eluting the target material, the eluting of the target material is not necessary. That is, the target material can be detected using a detector installed in the membrane itself and then used in the assay.

FIG. 3 is a schematic view of a microfluidic device according to another embodiment of the present invention. The device of FIG. 3 is the same as the device of FIG. 1 except that the electrodes respectively contact upper and lower surfaces of the membrane. Referring to FIG. 3, when a voltage is applied to the device through the electrodes by the power source, the strongest electric field is generated in the surface or inside of the pores so that a material with (+) DEP property is trapped.

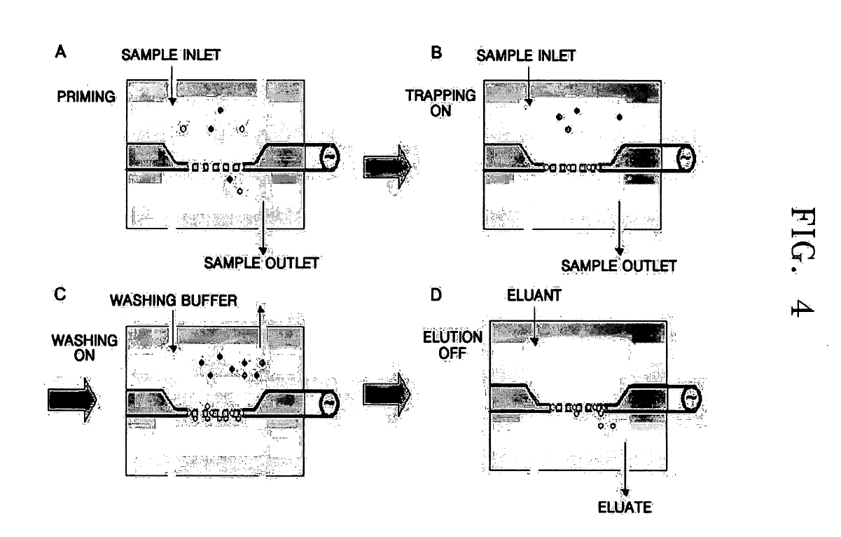

FIG. 4 illustrates steps in a process for enriching or separating a material via (+) DEP using the microfluidic device of FIG. 3. The process may include: a) injecting a sample containing a target material to the device; b) generating a spaciously asymmetric electric field by applying an AC voltage to the electrodes so that a material with a (+) DEP property is trapped in a region adjacent to the membrane and a material with a (−) DEP property is located above the membrane; c) washing materials that are not trapped with a washing buffer; and d) removing the electric field and eluting the trapped target material, or directly detecting the target material.

The present invention will be described in further detail with reference to the following examples. These examples are for illustrative purposes only and are not intended to limit the scope of the present invention.

### EXAMPLES

### Example 1

DEP properties of latex beads having diameters of 50 nm and 200 nm with respect to a frequency were identified through simulation. The devices illustrated in FIG. 1 and FIG. 3 were used to separate the latex beads.

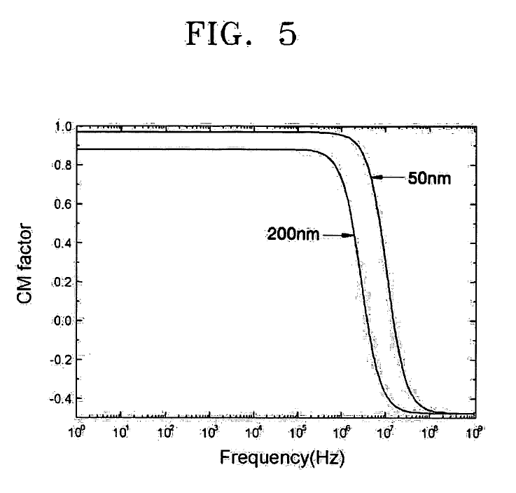

FIG. 5 is a graph illustrating a DEP property with respect to a frequency of latex beads having diameters of 50 nm and 200 nm. The CM factor of FIG. 5 was given by
CM factor =RE[εₚ*−εₘ*]/(εₚ*+2εₘ*)
Where ε* (complex permittivity)=ε−i(σ/ω), where σ is conductivity and ω=2πf.

The parameters used in the above calculation formula for the latex beads are εₚ=2.55, σₚ for the 200 nm beads=23.2 mS/m and σₚ for the 50 nm beads=92.8 mS/m calculated according to formula

$${σ}_{P} = {σ}_{bulk} + 2 ( {K}_{S} / r )$$

using σ_{bulk}=0, surface conductance Kₛ=2.3 nS, permittivity and conductivity of the buffers, εₘ=78, σₘ=1 mS/m, respectively.

Referring to FIG. 5, at a frequency of 10⁷ Hz, the latex bead with a diameter of 50 nm exhibited a (+) DEP property, and the latex bead with a diameter of 200 nm exhibited a (−) DEP property. Thus, the latex beads with diameters of 50 nm and 200 nm could be separated at the frequency of 10⁷ Hz.

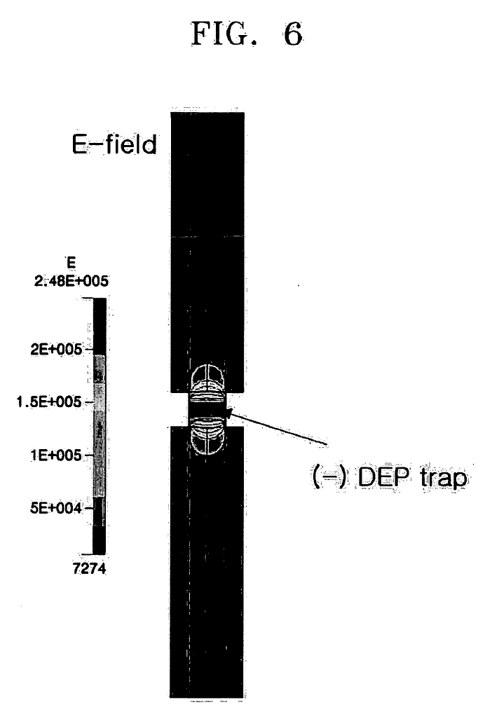

FIG. 6 is a view illustrating a separation result of latex beads with diameters of 50 nm and 200 nm using the microfluidic device of FIG. 1, which includes a membrane with a thickness of 2 μm, pores of 2 μm in diameter, and electrodes respectively separated from the membrane by a distance of 50 μm. In this case, a Vpp of 20 V and a frequency of 10⁷ Hz were used, the membrane had an area of 100 mm², and a linear speed of the fluid was 2 mm/sec. As illustrated in FIG. 6, particles with a diameter of 200 nm were enriched in the pores by (−) DEP.

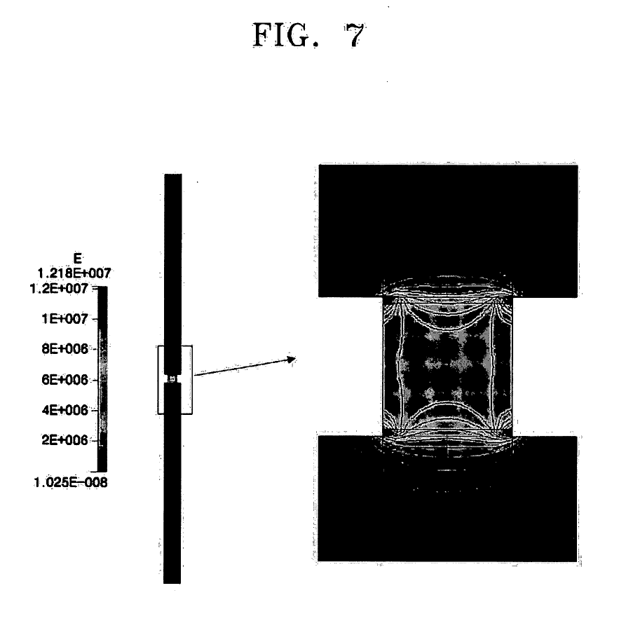

FIG. 7 is a view illustrating an electric field distribution adjacent to the membrane when an electric field was applied to the microfluidic device of FIG. 3 which included the membrane with a thickness of 2 μm, pores of 2 μm in diameter, and electrodes respectively contacting the membrane according to an embodiment of the present invention.

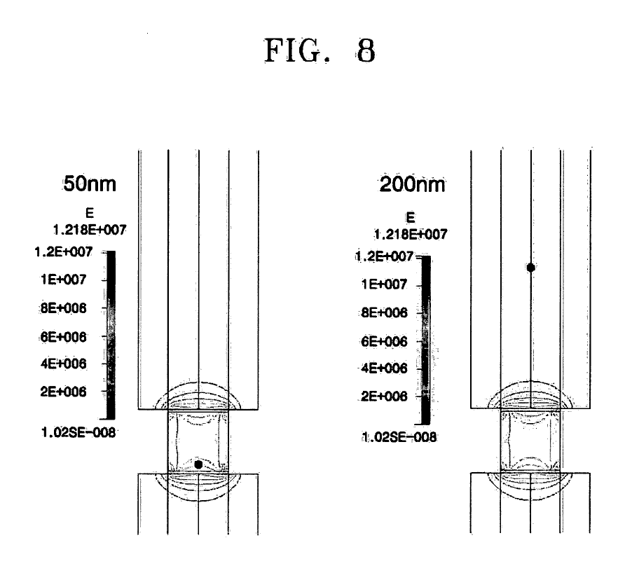

FIG. 8 is a view illustrating separation results of latex beads with diameters of 50 nm and 200 nm using the microfluidic device of FIG. 3, which includes the membrane with a thickness of 2 μm, pores of 2 μm in diameter, and electrodes respectively contacting the membrane according to an embodiment of the present invention. In this case, a Vpp of 10V and a frequency of 10⁷ Hz were used, the area of the membrane was 100 mm², and the linear speed of the fluid was 5 mm/s. As illustrated in FIG. 8, the latex bead with the diameter of 50 nm was enriched in the pores by (+) DEP. The present simulation was performed using a CFDRC™ program (obtained from CFD Research Corporation Co.). In FIGS. 6, 7, and 8, the brightness of the color corresponds to the strength of the electric field.

A microfluidic device according to the present invention includes a plurality of nano- to micro-sized pores and polarizable target materials can be separated in respective pores. As a result, the separation capacity can be increased, and the likelihood of clogging can be decreased. In addition, because nano-sized pores can be formed, nano-sized materials can be effectively separated.

According to a method of the present invention, a large quantity of polarizable target materials can be efficiently separated or detected.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A microfluidic device for separating polarizable analytes via dielectriophoresis, the device comprising:
a microchannel comprising a membrane having nano- to micro-sized pores;
at least two electrodes generating a spaciously non-uniform electric field in the nano- to micro-sized pores when an AC voltage is applied; and
a power source applying the AC voltage to the electrodes.

2. The device of claim 1, wherein the microchannel and the membrane are formed of an insulating material.

3. The device of claim 1, wherein the thickness of the membrane is in the range of 0.1 μm to 500 μm.

4. The device of claim 1, wherein the diameter of the pores is in the range of 1 μm to 50 μm.

5. The device of claim 1, wherein the depth of the pores is in the range of 0.1 μm to 500 μm.

6. The device of claim 1, further comprising a detector.

7. A method of separating a target material from a sample via dielectricphoresis using the microfluidic device of claim 1 comprising: the microchannel including the membrane having nano- to micro-sized pores, at least two electrodes, and the power source, the method comprising:
contacting the sample and the membrane having nano- to micro-sized pores; and
generating a spaciously non-uniform electric field in the vicinity of the nano- to micro-sized pores of the membrane by applying an AC voltage to the electrodes by the power source so that the target material is separated from the sample via dielectrophoresis.

8. The method of claim 7, further comprising eluting the separated target material.

9. The method of claim 7, further comprising detecting the separated target material.
